(19) United States
(12) Patent Application Publication
(10) Pub. No.: US 2016/0051116 A1
(43) Pub. Date: Feb. 25, 2016

(54) SPRAY NOZZLE

(71) Applicant: Techtronic Industries Co., Ltd., Tsuen Wan (HK)

(72) Inventors: Christopher M. Charlton, Medina, OH (US); Justin C. Andrikanich, Stow, OH (US)

(21) Appl. No.: 14/835,643

(22) Filed: Aug. 25, 2015

Related U.S. Application Data
(60) Provisional application No. 62/041,502, filed on Aug. 25, 2014.

(51) Int. Cl. A47L 13/22; B05B 1/30

(52) U.S. Cl. CPC A47L 13/22; B05B 1/3006

(57) ABSTRACT

A spray nozzle includes a nozzle housing formed of a first material and a nozzle tip having a spray opening formed of a second material. The second material has a greater resiliency than the first material. The nozzle tip has a spray opening that is closed inhibiting air entry into the nozzle housing in a first configuration and opened in a second configuration. The spray nozzle changes from the first configuration to the second configuration by an increase of pressure of the liquid in the spray nozzle operable to spray liquid out of the opened spray opening in the second configuration. A method of using the spray nozzle is also provided.

### CROSS-REFERENCE TO RELATED APPLICATIONS

This application claims priority to U.S. Provisional Patent Application No. 62/041,502, filed on Aug. 25, 2014, the contents is hereby incorporated by reference in its entirety.

### FIELD OF THE INVENTION

The present invention relates to a spray nozzle. More specifically, the present invention relates to a multi-material spray nozzle, a method of use, and a method of manufacture.

### BACKGROUND

A spray nozzle facilitates dispersion of a liquid into a spray for distribution over an area. Generally, the spray nozzle is in fluid communication with a liquid source and includes an outlet. As liquid from the source passes through the spray nozzle and exits through the outlet, the spray nozzle uses the kinetic energy of the liquid to atomize the liquid into droplets.

Spray nozzles can be configured to provide different spray characteristics. For example, spray nozzles can atomize liquids into different droplet sizes. Generally, as fluid pressure in the spray nozzle increases, flow through the nozzle increases, and fluid droplet size decreases. Accordingly, by adjusting fluid pressure and/or flow through the nozzle, droplet size can be increased or decreased. Other spray characteristics influenced by spray nozzle configuration includes spray pattern, spray volume or capacity, spray impact, and spray angle.

Spray nozzles are typically manufactured from a single material, such as brass, stainless steel, plastics, or ceramics. The material selected typically depends on spray application factors, including erosive wear, chemicals, and temperature encountered during use.

### SUMMARY OF THE INVENTION

The invention provides, in one aspect, a spray nozzle including a nozzle housing formed of a first material; and a nozzle tip having a spray opening formed of a second material, wherein the second material has a greater resiliency than the first material.

The invention provides, in another aspect, a spray nozzle including a nozzle housing, and a nozzle tip formed of a flexible material having a spray opening that is closed inhibiting air entry into the nozzle housing in a first configuration and opened in a second configuration. The spray nozzle changes from the first configuration to the second configuration by an increase of pressure of the liquid in the spray nozzle operable to spray liquid out of the opened spray opening in the second configuration.

The invention provides, in another aspect, a spray mop including a handle, a head portion attached to the handle, a reservoir, a spray nozzle in communication with the reservoir, and a pump in communication with the reservoir operable to pressurize fluid in the spray nozzle. The spray nozzle includes a nozzle housing, and a nozzle tip formed of a flexible material having a spray opening that is closed in a first state and opened in a second state, where the spray nozzle changes from the first state to the second state by an increase of pressure of the liquid in the nozzle housing operable to spray liquid out of the opened spray opening in the second state.

The invention provides, in another aspect, a method of using a spray nozzle including providing the spray nozzle in a first state, the spray nozzle including a nozzle housing formed of a first material, and a nozzle tip formed of a second material with greater resiliency than the first material, the nozzle tip having a spray opening formed in the second material that provides a liquid seal in the first state, overcoming the liquid seal, and spraying the liquid out of the spray nozzle in a second state.

Other features and aspects of the invention will become apparent by consideration of the following detailed description and accompanying drawings.

### BRIEF DESCRIPTION OF THE DRAWINGS

FIG. 1 is an elevation view of a wet mop incorporating a spray nozzle in accordance with an embodiment of the invention.

FIG. 2 is a side view of the wet mop of FIG. 1, taken along line 2-2 of FIG. 1, illustrating the spray nozzle mounted on a portion of the wet mop.

FIG. 3 is a partial isometric view of the wet mop of FIG. 1, taken along line 3-3 of FIG. 2, illustrating a close up of the spray nozzle provided on a liquid distribution housing.

FIG. 4 is a partial cross-sectional view of the wet mop of FIG. 1, taken along line 4-4 of FIG. 3, illustrating a cross-section of the spray nozzle fluidly connected to a liquid dispersion chamber.

FIG. 5 is a schematic diagram of a method of using the spray nozzle to spray a liquid.

FIG. 6 is a schematic diagram of a method of manufacturing the spray nozzle.

Before any embodiments of the present invention are explained in detail, it should be understood that the invention is not limited in its application to the details or construction and the arrangement of components as set forth in the following description or as illustrated in the drawings. The invention is capable of other embodiments and of being practiced or of being carried out in various ways. It should be understood that the description of specific embodiments is not intended to limit the disclosure from covering all modifications, equivalents and alternatives falling within the spirit and scope of the disclosure. Also, it is to be understood that the phraseology and terminology used herein is for the purpose of description and should not be regarded as limiting.

### DETAILED DESCRIPTION

The invention illustrated in the Figures and disclosed herein is generally directed to a multi-material spray nozzle 100. The spray nozzle 100 is constructed of multiple materials, including a nozzle housing 110 formed of a first material 210 and a nozzle tip 120 formed of a second material 220. The nozzle tip 120 includes a spray opening 126. The spray opening 126 is closed in a first state and is open in a second state, for example the spray opening 126 is closed when a pump (not shown) is not actuated and is opened when the pump (not shown) is actuated. The second material 220 can be different than the first material 210. For example, the second material 220 can be more resilient or flexible than the first material 210. Stated otherwise, the first material 210 is more rigid than the second material 220. In the illustrated embodiments, the spray nozzle 100 is manufactured by overmolding the nozzle tip 120 onto the nozzle housing 110 to form a nozzle 100 having a one-piece or unitary construction. In some embodiments, the manufacturing process includes a secondary spray opening formation step, where a portion of the nozzle tip 120 is notched or cut to form the spray opening 126.

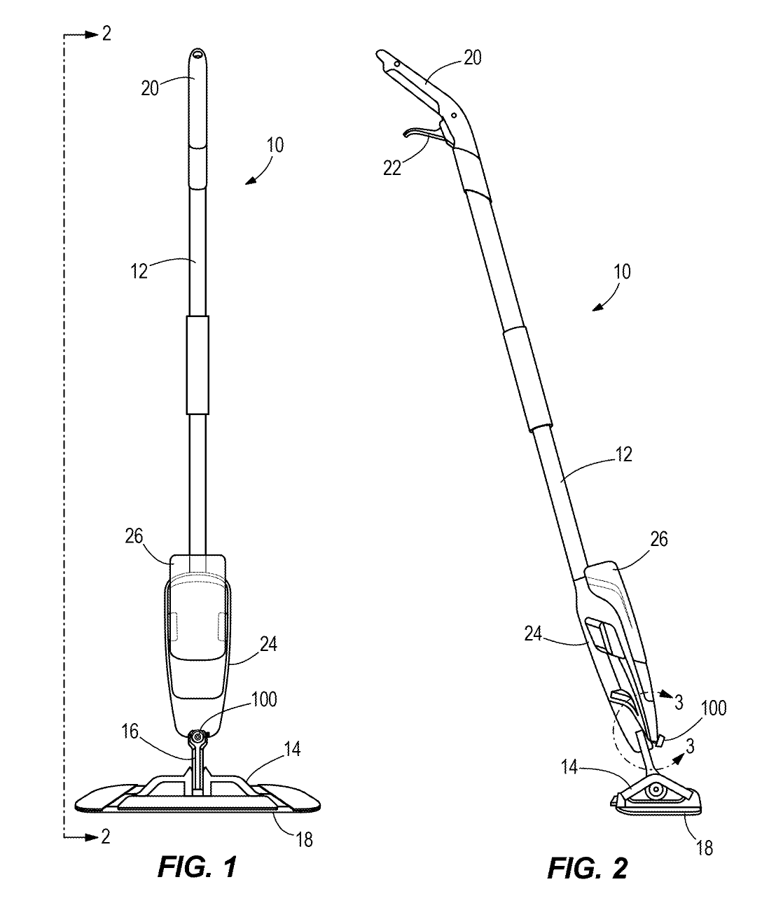

Referring now to the Figures, FIGS. 1-4 illustrate a wet mop or spray mop 10 that incorporates the novel spray nozzle 100 disclosed herein. It should be appreciated that the spray mop 10 is provided for purposes of illustration, and any device that sprays or atomizes a liquid may incorporate the spray nozzle 100.

Referring to FIGS. 1 and 2, the spray mop 10 includes a handle portion 12 coupled to a head portion 14 by a pivoting connection 16 (shown in FIG. 1). The head portion 14 includes a bottom surface 18 adapted to engage a cleaning media (not shown), such as a washable or replaceable cleaning pad. The pivoting connection 16 allows the handle portion 12 to move about the head portion 14 while the bottom surface 18 engages a surface targeted for cleaning, such as a floor.

The handle portion 12 includes a handle 20 and a trigger 22 (shown in FIG. 2), and carries a liquid distribution housing 24. The housing 24 includes a liquid reservoir 26 for containing a liquid dispersible by the spray mop 10 and a pump (not shown) actuatable by the trigger 22. The liquid reservoir 26 may be removable from the housing 24 for ease of filling or refilling with liquid. The liquid may be water, a cleaning solution, detergent, or any other suitable or desired fluid. The spray nozzle 100 may be positioned on the liquid distribution housing 24 or the head portion 14 forming a fluid connection by a liquid distribution system (not shown) including the liquid reservoir 26, the pump, and the spray nozzle 100.

In the illustrated embodiment, the pump (not shown) is operated by actuation of the trigger 22. The pump (not shown) may be a mechanically actuated piston pump that draws liquid from the reservoir 26 and discharges the liquid into the dispersion chamber 28 and through the nozzle tip 120. Alternatively, the pump (not shown) may be an electric pump.

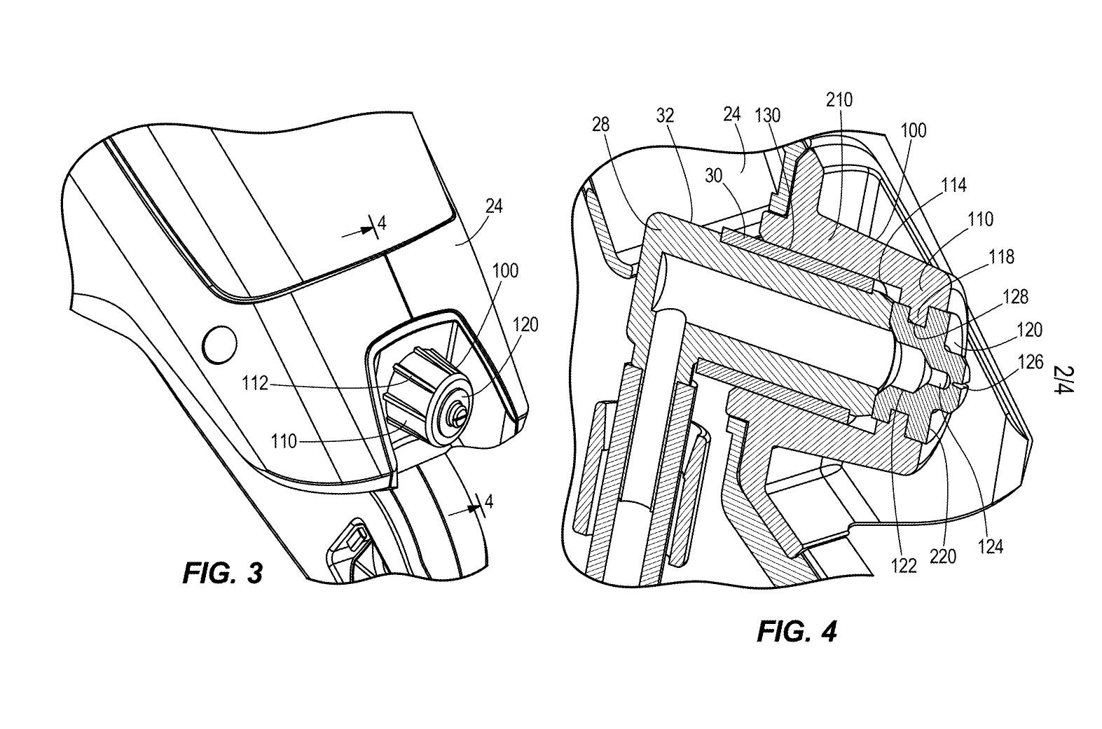

Referring now to FIG. 3, the spray nozzle 100 includes the nozzle housing or a first portion 110 and the nozzle tip or a second portion 120. The nozzle housing 110 is formed of the first material 210, while the nozzle tip 120 is formed of the second material 220. The second material 220 is more resilient than the first material 210, or stated otherwise, the first material 210 is more rigid than the second material 220. The second material 220 is a flexible material having a resiliency sufficient to create a liquid seal at the spray opening 126 that can be overcome by operation of the liquid distribution system (not shown). In various embodiments, the spray opening 126 is closed inhibiting air entry into the nozzle housing 110 in a first state and is open in a second state. Inhibiting air entry into the nozzle housing 110 reduces thickening or hardening of polishes and cleaners in the liquid distribution system (not shown). This enables use of such polishes and cleaners that typically clog spray mops 10, or other spraying or atomizing devices, prior to the present invention.

In the embodiment shown in FIG. 4, the nozzle housing 110 defines a projection 118 that projects inward from an inner circumference 114 of the spray nozzle 100. The projection 118 provides an interface surface with increased surface area to improve the retention of the nozzle tip 120 onto the nozzle housing 110 when the nozzle tip 120 is overmolded onto the nozzle housing 110. In the illustrated embodiment, the projection 118 is shown as an annular projection 118. However, in other examples of embodiments, the projection 118 can be any desired or suitable shape to facilitate a connection between the nozzle housing 110 and the nozzle tip 120. Alternatively or additionally, the projection 118 is received by a channel 128 defined by the nozzle tip 120. The channel 128 assists to retain the nozzle tip 120 in the nozzle housing 110. In the illustrated embodiment, the channel 128 is shown as an annular channel 128 that matches or facilitates mating with the projection 118. However, in other examples of embodiments, the channel 128 can be any desired or suitable shape to receive, mate, or connect to the projection 118 to facilitate the connection between the nozzle housing 110 and the nozzle tip 120. Other geometries may be provided for positioning and/or retaining the nozzle tip 120 in the nozzle housing 110. In other embodiments, the projection 118 may be defined by the nozzle tip 120, while the nozzle housing 110 defines the channel 128.

The spray nozzle 100 removably engages a dispersion chamber 28 carried by the liquid distribution housing 24 or the head portion 14. The dispersion chamber 28 is in fluid connection with the pump (not shown) to distribute liquid from the liquid reservoir 26 to the spray nozzle 100. As shown in FIG. 4, the resilient second material 220 of the nozzle tip 120 may be positioned to form a seal around the perimeter of the dispersion chamber 28 when the spray nozzle 100 is attached to the dispersion chamber 28. In the embodiment shown in FIG. 4, the spray nozzle 100 is threaded onto an outer circumference 32 of the dispersion chamber 28 to form a threaded attachment or fit. This threaded fit enables removal of the spray nozzle 100 from the dispersion chamber 28 to provide access for cleaning and/or replacement of the spray nozzle 100. To facilitate removal and/or attachment, ribs 112 may be provided about an outer surface of the spray nozzle 100 to provide a gripping surface suitable for the user to rotate the spray nozzle 100 about the dispersion chamber 28. In other examples of embodiments, the spray nozzle 100 may be retained by interlocking snap-fit features between the spray nozzle 100 and the dispersion chamber 28. In still other examples of embodiments, the dispersion chamber 28 may be substantially housed by the liquid distribution housing 24. In some of these embodiments, the spray nozzle 100 may removably engage a portion of the liquid distribution housing 24, while being in fluid communication with the dispersion chamber 28.

In the illustrated embodiment, the interior of the nozzle tip 120 defines a first narrowing diameter portion 122 leading to a second narrowing diameter portion 124 adjacent the spray opening 126 of the nozzle tip 120. The first and second narrowing diameter portions 122, 124 create a fluid connection between the dispersion chamber 28 and the spray opening or orifice or outlet 126 of the spray nozzle 100. The first narrowing diameter portion 122 has an inner diameter that is less than an inner diameter of the dispersion chamber 28, and the second diameter portion 124 has an inner diameter that is less than the inner diameter of the first narrowing diameter portion 122. In various embodiments, the spray opening 126 is a slit, and the second narrowing diameter portion 124 has a diameter larger than the length of the slit. In alternative embodiments, the nozzle tip 120 does not include one or both of the first and second narrowing diameter portions 122, 124, instead transitioning to a diaphragm (not shown) adjacent the spray opening 126.

In the first state, first configuration, or resting state, the spray opening 126 is closed to form a liquid seal. In the first state, the pressure in the spray nozzle 100 is not sufficient to overcome the liquid seal, and the spray opening 126 remains closed. An example of the spray mop 10 in the first state is when the pump (not shown) is not actuated.

The spray nozzle 100 changes from the first state to the second state, second configuration, or spraying state by an increase in pressure of the liquid in the spray nozzle 100. The increase in pressure is operable (or sufficient) to overcome the liquid seal, resulting in the spray of liquid out of the opened spray opening 126 in the second state. An example of the spray mop 10 in the second state is when the pump (not shown) is actuated to increase pressure in the spray nozzle 100.

The spray nozzle 100 returns to the first state by a decrease of pressure of the liquid in the spray nozzle 100, such as during the pressure release caused by the spray nozzle 100 spraying liquid. During the change from the second to the first state, the pressure in the spray nozzle 100 is no longer sufficient to overcome the liquid seal. The spray opening 126 then closes to reform the liquid seal in the first state. The resilient second material 220 forming the flexible spray opening 126 facilitates reformation of the liquid seal during the transition from the second state to the first state.

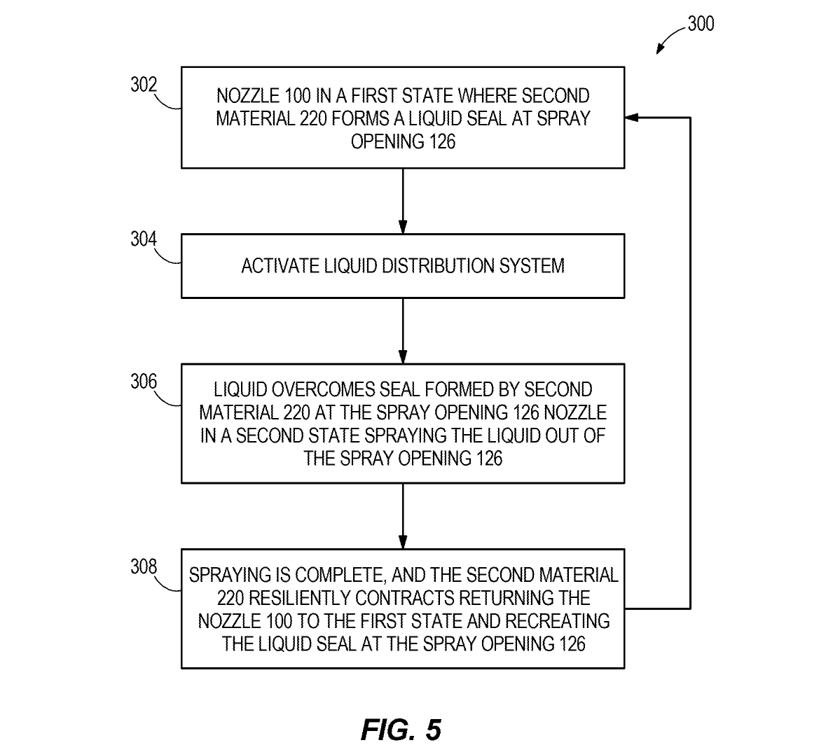

FIG. 5 illustrates an example of a method of spraying a liquid 300 with the spray nozzle 100. The method 300 discloses spraying in association with components of the mop 10, but the method may be performed with any suitable liquid spraying assembly having a liquid source and a spray assembly that incorporates the spray nozzle 100. The method 300 includes a series of operation steps that are depicted in flow diagram form. Referring to FIG. 5, the method 300 begins with the spray mop 10 in a “ready to use” state, where the liquid reservoir 26 contains a liquid, and the liquid is in fluid communication with the spray nozzle 100 through the liquid distribution system (not shown). At step 302 the spray nozzle 100 is in the first state where the second material 220 forms the liquid seal at the spray opening 126. The second material 220 resiliently contacts itself at the spray opening 126 to form the liquid seal, where any liquid in the dispersion chamber 28 is not able to escape through the spray opening 126 of the spray nozzle 100.

Next, at step 304, the liquid distribution system (not shown) is activated. During activation, liquid is provided from the liquid source to the spray nozzle 100. This increases the fluid pressure of the liquid at the spray nozzle 100. For example, in the spray mop 10, a user actuates the trigger 22, which pumps liquid through the liquid distribution system (not shown). Liquid travels from the liquid reservoir 26, through the pump (not shown), to the dispersion chamber 28, and then to the spray nozzle 100. At the spray nozzle 100, the fluid pressure of the liquid increases by introducing additional fluid to the dispersion chamber 28, and/or by encountering the first and second narrowing diameter portions 122, 124 of the spray nozzle 100.

At step 306, the liquid overcomes the liquid seal formed by the second material 220 at the spray opening 126 to open the spray opening 126. The increase in fluid pressure allows the liquid to overcome the liquid seal. In the illustrated embodiment, the second material 220 at the spray opening 126 separates from itself, opening the spray opening 126. Once the liquid seal is overcome, the spray nozzle 100 is in the second or spraying state, and the liquid sprays out of the spray opening 126 of the nozzle tip 120. It should be appreciated that the spray opening 126 may have a configuration suitable to provide a desired spray pattern.

Next, at step 308, the spraying is complete and the spray nozzle 100 returns to the first or resting state. The spraying is complete when the fluid pressure of the liquid at the spray nozzle 100 decreases such that the fluid pressure of the liquid is no longer sufficient to overcome the liquid seal. Stated otherwise, the liquid no longer separates the second material 220 at the spray opening 126. With the decrease in liquid fluid pressure, the resilient second material 220 collapses or closes around the spray opening 126, returning to contact itself at the spray opening 126. This reforms the liquid seal and returns the spray nozzle 100 to the first state. Once returned to the first state, the method returns to step 302 where the process of spraying with the spray nozzle 100 can repeat.

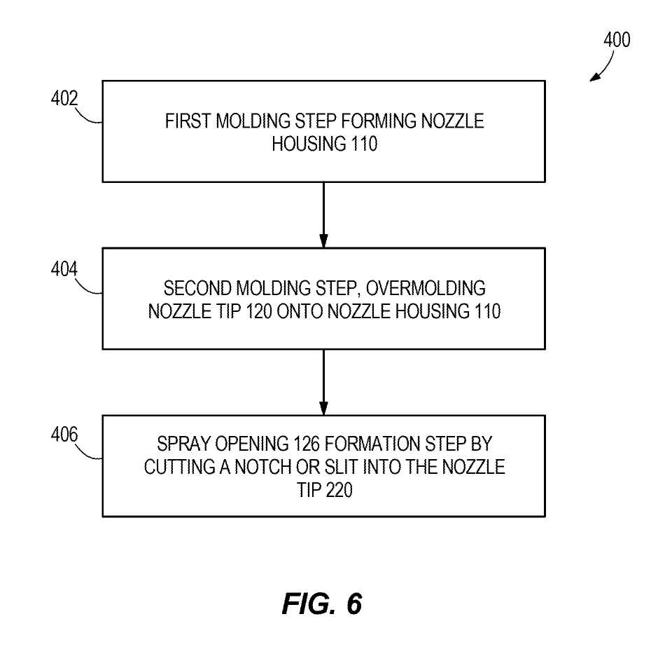

FIG. 6 illustrates an example of a process for manufacturing 400 the multi-material spray nozzle 100. The process 400 includes a series of manufacturing steps that are depicted in flow diagram form. In the manufacturing process, both the nozzle housing 110 and the nozzle tip 120 are injection-molded components. The nozzle housing 110 and the nozzle tip 120 are each formed with a single injection-molding shot. More specifically, the nozzle housing 110 is formed with a first injection-molding shot and the nozzle tip 120 is injection molded over the nozzle housing 110 with a second injection-molding shot. As a result, portions of the nozzle tip 120 take their shape as a result of molding around portions of the nozzle housing 110 (e.g., overmolding). This process results in a multi-material spray nozzle 100 that is formed as a unitary or one piece body. It should be appreciated that in other examples of embodiments of the process 400, the nozzle housing 110 can be injection molded over the nozzle tip 120. In addition, both the nozzle housing 110 and the nozzle tip 120 can include additional portions or components similar to those illustrated in the drawings and described herein.

Referring now to FIG. 6, the process 400 is an injection molding process that begins with a first molding step 402. The first molding step 402 involves molding the nozzle housing 110 with the first material. In an injection molding process, the first molding step 402 includes injecting or providing a first shot of the first material into a mold. The first material may be any suitable or desired material that provides for the features associated with the nozzle housing 110 and nozzle 100 disclosed herein. The first material includes, but is not limited to, metals, plastics, thermoplastics (such as high-density polyethylene), elastomers, or thermosetting polymers.

Next, the process 400 includes a second molding step 404 where the nozzle tip 120 is overmolded onto the nozzle housing 110. The nozzle tip 120 is formed from the second material having a higher resiliency than the first material. Overmolding in an injection molding process includes injecting or providing a second shot of the second material into the mold to form a layer around a portion of the first material. The first and second shots may use the same or different injection units. In addition, the overmolding may occur in a single molding cycle or over multiple molding cycles. The second material may be any suitable or desired material that provides for the features associated with the nozzle tip 120 and nozzle 100 disclosed herein, including sufficient resiliency to form the liquid seal at the spray opening 126 and suitable to transition between the first and second states. The second material includes, but is not limited to, metals, plastics, thermoplastics (such as high-density polyethylene), elastomers, or thermosetting polymers.

When molding is complete, the first and second materials form a one-piece construction, resulting in the spray nozzle 100 having a one-piece body formed from at least two materials, and more specifically from at least the first and second materials 210, 220.

In some embodiments of the manufacturing process 400, a secondary manufacturing step or operation is needed to form the spray opening 126. At step 406, an aperture, notch, slit, or puncture is made in the nozzle tip 120 to form (or define) the spray opening 126. Formation of the spray opening 126 may also include formation of a desired spray configuration, including a desired spray pattern, spray volume, spray impact, and/or spray capacity. The spray opening formation step 406 may be performed by equipment separate from the injection molding equipment that performs steps 402 and 404, or incorporated into the injection molding equipment.

The spray nozzle 100 provides a removable, replaceable, multi-material nozzle construction for spraying liquids that is durable and cost effective to manufacture. The multi-material nozzle construction also advantageously inhibits air entry, reducing thickening or hardening of certain polishes and cleaners in the liquid distribution system, and enabling the use of such polishes and cleaners that typically clog liquid distribution systems and/or nozzles known prior to the present invention. These and other advantages may be realized from one or more embodiments of the spray nozzle 100 disclosed herein.

What is claimed is:

1. A spray nozzle comprising:
a nozzle housing formed of a first material; and
a nozzle tip having a spray opening formed of a second material, wherein the second material has a greater resiliency than the first material.

2. The spray nozzle of claim 1, wherein the nozzle tip is formed of a flexible material such that the spray opening is closed inhibiting air entry into the nozzle housing in a first state and opened in a second state.

3. The spray nozzle of claim 1, wherein the nozzle tip includes a first narrowing portion and a second narrowing portion in fluid communication with the spray opening, the second narrowing portion having an inner diameter that is less than an inner diameter of the first narrowing portion. The spray nozzle of claim 1, wherein the spray opening is a slit.

5. The spray nozzle of claim 1, wherein the spray opening forms a liquid seal in a first state and sprays liquid out of the nozzle tip in a second state.

6. The spray nozzle of claim 5, wherein the resiliency of the second material closes the spray opening forming the liquid seal in the second state.

7. The spray nozzle of claim 5, wherein the spray opening sprays liquid out of the nozzle tip by separating the second material at the spray opening.

8. The spray nozzle of claim 5, wherein a fluid pressure of a liquid in contact with the spray nozzle influences the spray opening between the first and second states.

9. The spray nozzle of claim 1, wherein the nozzle housing and nozzle tip form a unitary construction.

10. The spray nozzle of claim 9, wherein a channel is defined by the nozzle tip that receives a projection that projects from the nozzle housing towards the nozzle tip.

11. A spray nozzle comprising:
a nozzle housing, and
a nozzle tip formed of a flexible material having a spray opening that is closed inhibiting air entry into the nozzle housing in a first configuration and opened in a second configuration,
where the spray nozzle changes from the first configuration to the second configuration by an increase of pressure of the liquid in the spray nozzle operable to spray the liquid out of the opened spray opening in the second configuration.

12. The spray nozzle according to claim 11, where the spray nozzle changes from the second configuration to the first configuration by a decrease of pressure of the liquid in the spray nozzle closing the spray opening forming a liquid seal in the first configuration.

13. The spray nozzle according to claim 11, where the resiliency of the flexible material closes the spray opening forming a liquid seal in the first configuration.

14. The spray nozzle according to claim 11, where the spray opening is a slit.

15. The spray nozzle according to claim 11, further comprising:
a spray mop including:
a handle, a head portion attached to the handle, a reservoir, the spray nozzle in communication with the reservoir, and a pump in communication with the reservoir operable to pressurize fluid in the spray nozzle.

16. The spray nozzle according to claim 15, where the spray nozzle changes from the second configuration to the first configuration by a decrease of pressure of the liquid in the nozzle housing closing the spray opening forming a liquid seal in the first configuration.

17. The spray nozzle according to claim 11, wherein a channel is defined by one of the nozzle tip or the nozzle housing, the channel receives a projection that projects from the other of the nozzle housing or the nozzle tip.

18. A method of using a spray nozzle comprising:
providing the spray nozzle in a first state, the spray nozzle including a nozzle housing formed of a first material, and a nozzle tip formed of a second material with greater resiliency than the first material, the nozzle tip having a spray opening formed in the second material that provides a liquid seal in the first state;
overcoming the liquid seal opening the spray nozzle in a second state; and
spraying the liquid out of the spray nozzle in the second state.

19. The method of claim 18, wherein the overcoming step comprises increasing a fluid pressure of a fluid in communication with the spray nozzle.

20. The method of claim 19, further comprising reinstating the liquid seal to terminate spraying by decreasing the fluid pressure of the fluid in communication with the spray nozzle.
